(19) United States
(12) Patent Application Publication
(10) Pub. No.: US 2011/0290882 A1
(43) Pub. Date: Dec. 1, 2011

(54) QR CODE DETECTION

(75) Inventors: Zhiwei Gu, Beijing (CN); Matthew R. Scott, Beijing (CN); Gang Chen, Beijing (CN); Jonathan Y. Tien, Beijing (CN)

(73) Assignee: Microsoft Corporation, Redmond, WA (US)

(21) Appl. No.: 12/790,125

(22) Filed: May 28, 2010

(51) Int. Cl. G06K 7/10

(52) U.S. Cl. 235/462.11

(57) ABSTRACT

One or more techniques and/or systems are disclosed for detecting a quick response (QR) code. An area of an image comprising a QR code is localized by combining pixel dynamic scale (DS), black-cell ratio (BR), and edge intensity sum (EIS) criteria determination to identify the QR code. A pattern for the QR code is detected, comprising determining if a position detection pattern (PDP) is located in respective grid areas of a first grid that comprises the QR code, and identifying an alignment pattern (AP), if present. To identify the AP, an AP region is estimated using the PDPs, and a center area of the AP is found by examining respective areas of a second grid comprising the estimated AP region.

### BACKGROUND

Bar codes are widely popular due to their ability to store information in a small space that can be read quickly, accuracy, and from a variety of perspectives. As bar codes became popular and their convenience recognized, the market began to address a need for codes that could store more information, more character types, and could also be printed in a small space like the barcode. A quick response (QR) Code is a two-dimensional barcode (e.g., information provided in two dimensions) that was approved as an ISO international standard (ISO/IEC18004).

The QR Code contains information in both vertical and horizontal directions, whereas a bar code contains data in only one direction (horizontally). Therefore, a QR Code can hold a greater volume of information than a bar code, and are often used to contain web address, a message, contact information, and more. Commonly, commercial interests will place a QR code in an advertisement, which when activated leads a consumer to a website or some other information. For example, a consumer may see a billboard that has a QR code, take a picture or video with their smart phone, and a decoder in the phone can automatically direct the consumer to a website using the QR code.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Current techniques and systems for decoding a 2D barcode format called “OR Code” on low grade devices such as mobile devices (e.g., smart phones) have sub-optimal performance. For example, the current system may not offer a fast real-time experience of detecting and decoding a OR code. Typically, these state-of-the-art solutions either have a delayed video stream or require that the user to take a photo of the QR code, then perform decoding in a separate act, instead of “on-the-fly.” It is likely that the slow performance of these current decoding solutions is because the decoding algorithm used may not be effective on low grade devices (e.g., those with poor image quality).

Accordingly, one or more techniques and/or systems are disclosed that can overcome deficiencies of images collected from low-grade devices. A spot center that comprises the QR code, for example, can be supplied by the user capturing the image, and a two phase QR code detection can be applied. Wasted computational time can be mitigated by performing a fast check of the image for a QR code, and the patterns typically found in all QR codes are quickly identified.

In one embodiment for detecting a quick response (QR) code, an area of an image that has a QR code is localized by combining pixel dynamic scale (DS), black-cell ratio (BR), and edge intensity sum (EIS) criteria determination to identify the QR code. A pattern for the QR code is detected by determining if a position detection pattern (PDP) is located in grid areas of a first grid that comprises the QR code. Further, detecting a pattern for the QR code comprises identifying an alignment pattern (AP), if present. To identify the AP an AP region is estimated using the PDPs determined, and a center area of the AP is found by examining respective areas of a second grid overlaying the estimated AP region.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for detecting a QR code.

FIG. 2 is an illustration of an example embodiment of a captured image.

FIG. 3 is an illustration of an example QR code.

FIG. 4 is a flow diagram illustrating an exemplary embodiment of a portion of a method where an area of an image comprising a QR code can be localized.

FIG. 5 is a flow diagram illustrating an exemplary embodiment of a portion of a method where PDPs can be identified for the QR code.

FIG. 6 is a flow diagram illustrating an exemplary embodiment of a portion of a method where AP center can be determined.

FIG. 7 is an illustration of an example QR code.

FIG. 8 is an illustration of an example QR code comprising a grid.

FIGS. 9A-B is an illustration of an example grid square scan.

FIG. 10 is an illustration an example estimated AP region comprising a grid.

FIG. 11 is a block diagram illustrating an exemplary system for detecting a QR code.

FIG. 12 is a component diagram illustrating an exemplary embodiment of a portion of a system, where a QR code can be extracted from the image.

FIG. 13 is an illustration of an exemplary computer-readable medium comprising processor-executable instructions configured to embody one or more of the provisions set forth herein.

FIG. 14 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Often, mobile devices, such as mobile smart phones with video capture, provide low-grade images. As such, for example, these low grade images may result in a slowed QR code detection experience. A method may be devised that provides for improved detection of quick response (QR) codes (e.g., two-dimensional barcodes). For example, mobile devices that have an ability to capture images can employ this method to provide for a fast, real-time experience in detecting the QR codes.

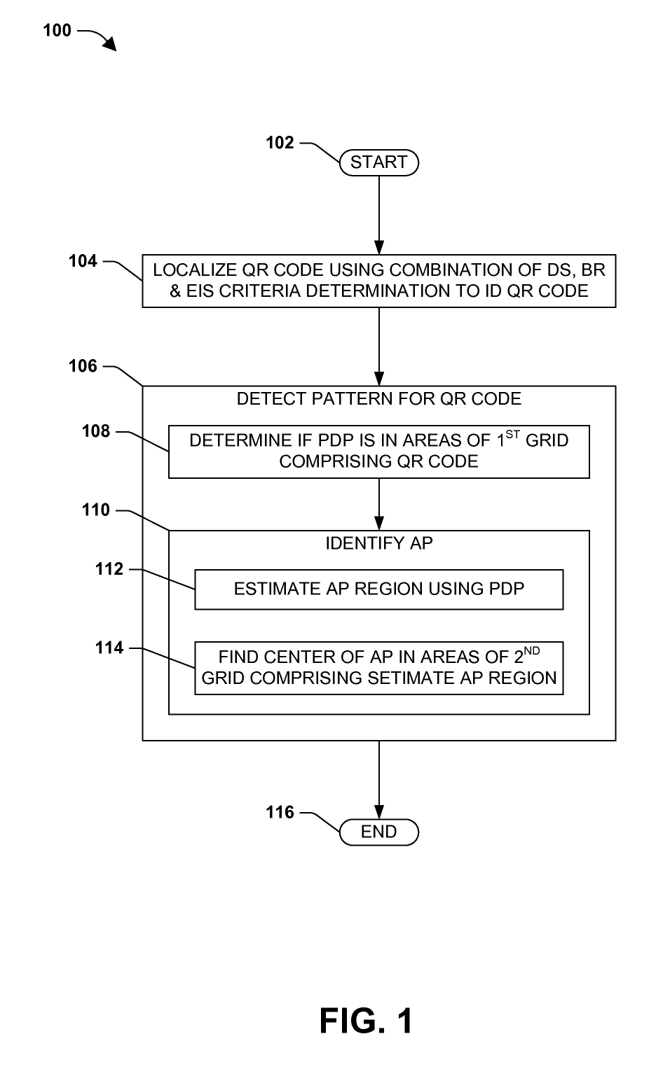

FIG. 1 is a flow diagram illustrating an exemplary method 100 for detecting a QR code. The exemplary method 100 begins at 102 and involves localizing an area of an image that comprises the QR code by combining criteria determination to identify the QR code, where the criteria comprise pixel dynamic scale (DS), black-cell ratio (BR), and edge intensity sum (EIS), at 104. For example, a mobile user may use their mobile device to capture an image that includes a QR code, such as a still picture or video. In this example, the captured image can comprise not only the QR code but other items that may have been in the frame when the image was captured. In this embodiment, the area of the image that comprises the QR code can be localized, for example, in order to facilitate QR code detection.

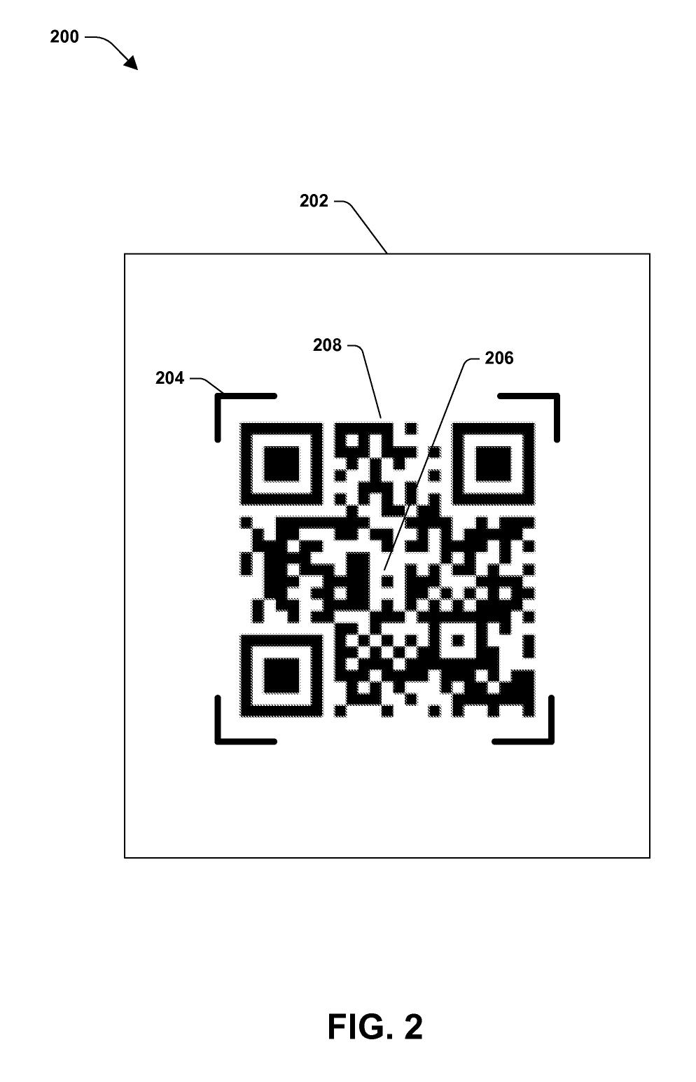

FIG. 2 is an illustration of an example embodiment of a captured image 200. In one embodiment, a QR code capture application may provide for the user to frame 204 an area of the image 202 that comprises the QR code 208. In this embodiment, framing the area 204 of the image 202 that comprises the QR code 208 can facilitate localization of the QR code. For example, it may be presumed that the QR code 208 is localized around a center 206 of the area framed 204 by the user. In one embodiment, a spot center (e.g., 206) provided by the user, such as during image capture (e.g., locating a target center on a center of the QR code during image capture) can be used to localize the QR code.

Further, in one embodiment, a combination of the DS, BR, and EIS criteria determination is used to help localize the QR code in the image. The DS can comprise a range of grayscale values for an image (or portion thereof). For example, an upper (U) and lower (L) limit for a grayscale histogram can be selected, and the DS can comprise the upper limit less the lower limit plus one unit of value (e.g., DS=U−L+1). As an example, the upper and lower limits may comprise five percent of the grayscale image histogram.

The BR can comprise a ratio of black cells to white cells in a selected area. For example, the image of the QR code can be binarized to generate a more ordered version of the QR code. That is, for example, a captured image of a QR code may not be in proper focus, could have rotational distortions, and/or other surface distortions that create varieties of grayscale and other image distortions. In one embodiment, a binarized version comprises uniform blocks of merely black and white cells (e.g., or only two different colors) that are derived from the captured image. In FIG. 2, the QR code 208 is an example of a binarized version, where the cells that make up the QR code are only black and white. For example, the number of black filled cells can be counted effectively in this QR code 208. In another embodiment, the BR may be determined from an image that is not binarized.

The EIS can comprise a summation of a gradient at a detected edge. For example, a QR code area is relatively filled with more diversity cells that other image objects. In this example, a texture characteristic of the QR code is rich (e.g., comprising a relative large number of hard edges due to the plurality of dark and light blocks), so a simple edge intensity sum can be used to measure the richness. In one embodiment, a Sobel mask can be used, where edges are detected by using a dynamic scale of a pixel value, and determining a gradient for the pixel. For example, an edge may be detected where the value of the gradient exceeds some threshold, as edges will have higher pixel intensity values than those surrounding it. In this embodiment, the gradients can be summed for the detected edges to yield the EIS.

In one embodiment, the captured image can be divided into a plurality of equal size squares, for example, and respective squares can be examined using the combination of the criteria, described above, to determine if a QR code is present. For example, the DS for the selected image area can be checked against a desired threshold, such as determined from experimentation, to see if it meets a threshold that identifies a QR code. Further, for the respective squares, the EIS can be checked against a desired threshold, such as to see if it is higher than the DS multiplied by the square size (e.g., a square size of 32 by 32 pixels). Additionally, the BR can be checked to see if is within a desired threshold range, such as 0.2<=BR<=0.7, for the image area. In this way, if the combination of the criteria for selected image area meet the respective thresholds, a QR is detected in the image.

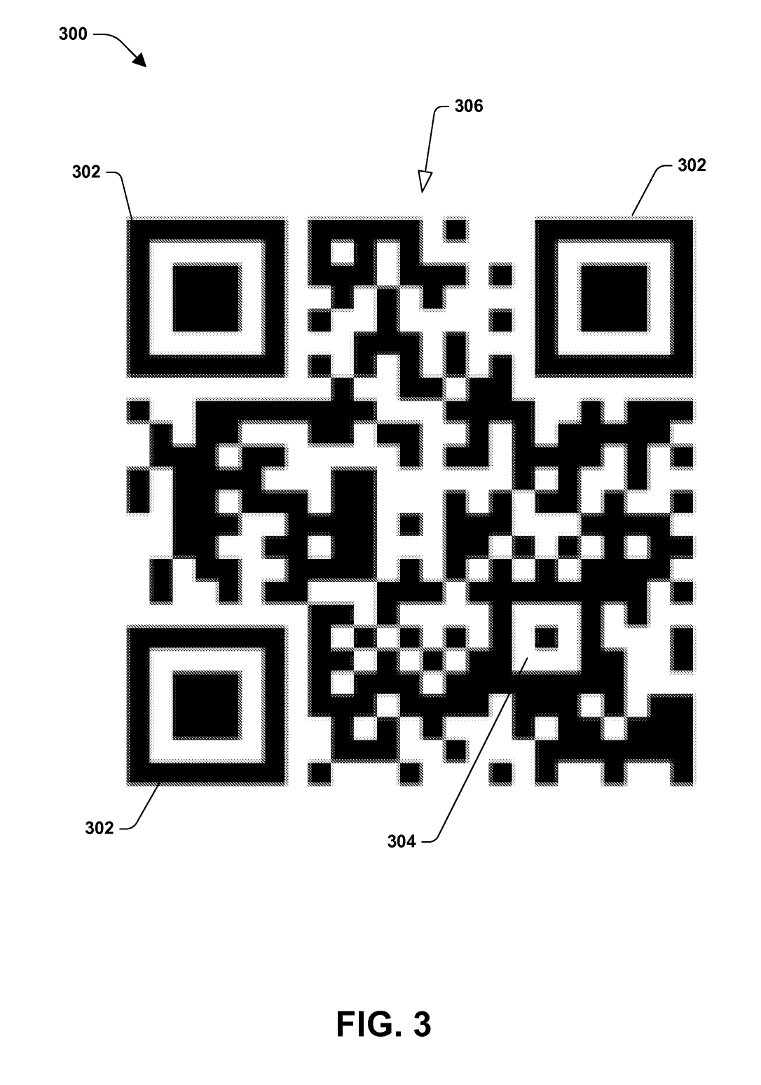

Returning to FIG. 1, at 106 of the exemplary method 100, a pattern for the QR code is detected. At 108, detecting the QR code pattern comprises determining whether a position detection pattern (PDP) is located in respective areas of a first grid that comprises the QR code. For example, a QR code usually comprises three PDPs, which are located at a corner area of the QR code. FIG. 3 is an illustration of an example QR code 300. In this example 300, the PDPs 302 are located at corners of the QR code 300. The PDPs typically comprise a series of three concentric squares of alternating colors (e.g., binary, comprising two colors, such as black and white). Further, the PDPs can be used to determine an orientation and potential distortion of the QR code.

In this embodiment, the localized area comprising the QR code can be divided into a grid, for example, and respective squares of the grid can be scanned for a PDP. For example, a QR Code can be read from a plurality of directions (e.g., omni-directional, 360 degree rotation), which is accomplished by locating the PDPs at three corners of the QR code. These PDPs, for example, are finder patterns that locate the orientation of the code, by arranging the PDPs in three of the code's corners to enable high-speed reading in all directions.

In one embodiment, using the grid to divide the QR code can reduce an amount of time used to find the three PDPs, for example. In this example, because the PDPs are located at three corners of the code, the areas of the grid that comprise the corners can be scanned first. If the PDPs are found in the first three or four grid square, comprising the corners of the code, the search for the PDPs can stop, for example, thereby eliminating the search of the remaining squares.

At 110, in the exemplary method 100, an alignment pattern (AP) is identified, if one is present in the QR code. For example, QR code can be distorted when captured from a curved surface or having the camera tilted. In one embodiment, to correct these types of distortion, one or more APs can be arranged at regular intervals within body of the code. In this embodiment, a variance between a center position of the AP, such as estimated from the outer shape of the QR code, and an actual center position of the AP can be determined in order to correct the distortion. As an example, the correction can make a distorted QR code more likely to be readable.

QR codes can be created in different version. For example, a version 1 code comprises 21 modules, while a version 2 code comprises 25 modules. In FIG. 3, the example QR code 300 comprises twenty-five by twenty-five modules 305 in the body of the code (e.g., where respective modules comprise a black or white cell/square that make up the body of the code, and there are 25 modules across and down), comprising a version 2 QR code. This example code 300 further comprises an AP 304, for example, which can be made up of concentric squares of opposite colors (e.g., binary).

At 112, identifying the AP comprises estimating an AP region of the QR code using the PDPs. In one embodiment, where an AP is present in the QR code, the AP is typically located in a corner area that is not occupied by a PDP, for example. In FIG. 3, the AP 304 is located in the bottom left corner, where the three PDPs 302 are located in the other corners of the QR code 300.

It will be appreciated that not all QR codes comprise APs, for example, such as some version 1 QR codes that comprise 21 modules. Further, some QR codes comprise more than one AP, such as version seven codes that can comprise six APs. Typically, the number of APs is equal to the version number minus one. As an example, the APs can be located at the other, non-PDP corner, the center, and areas between the PDPs, depending on the number of AP, and version number.

At 114, identifying the AP comprises finding a center area of the AP by examining respective areas of a second grid made up of the estimated AP region. For example, when the estimated AP region was determined, as described above, an estimated AP center can also be determined, such as by using the center of the second grid as the approximate center. In this embodiment, in order to determine the actual center of the AP, for example, the squares of the second grid can be examined for the actual center. In one embodiment, for example, a distortion of the QR code can be determined (if present) by calculating a difference between the estimated center and actual center of the AP.

Having identified the PDPs and AP, the exemplary method 100 ends at 116.

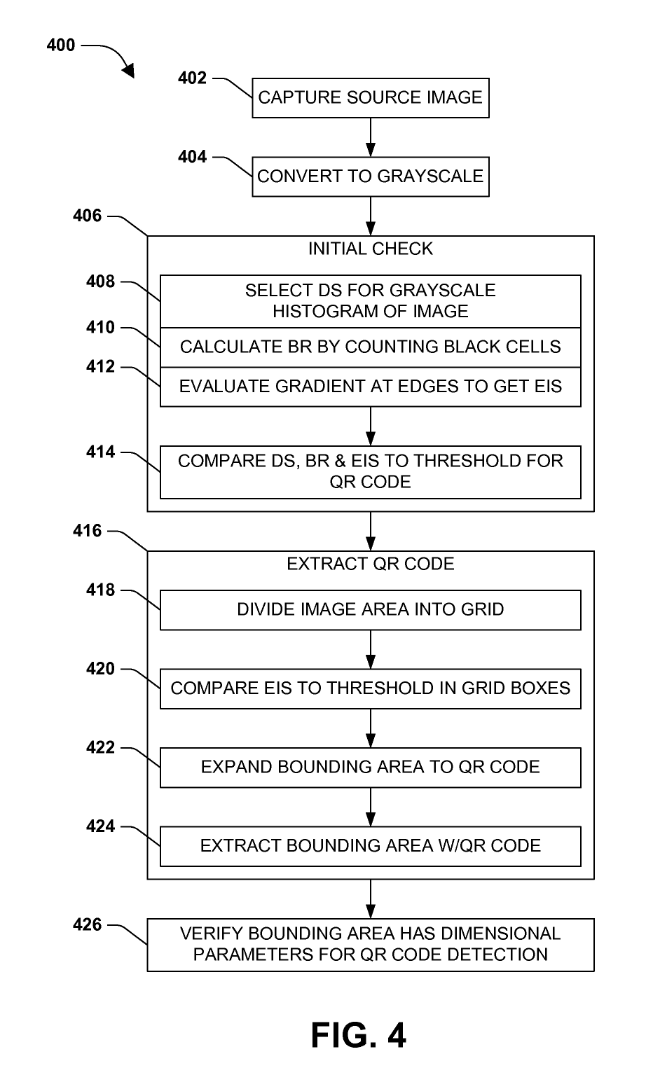

FIG. 4 is a flow diagram illustrating an exemplary embodiment 400 of a portion of a method where an area of an image comprising a QR code can be localized. At 402, a source image is captured, such as by a mobile device (e.g., smart phone, netbook, camera, etc.), for example, where a user captures an image that includes a QR code (e.g., to get an instant digital coupon). It will be appreciated that the image may be a single still photograph or a video, from which one or more frames are used for decoding.

At 404, the image can be converted to grayscale. For example, image capture devices typically capture color images, and converting the image to grayscale can facilitate in the detecting and decoding of the QR code. For example, when binarizing the QR code to merely comprise 2 colors, such as black and white, a threshold can be used to selected black or white cells. Further, the grayscale version is useful in performing a preliminary check for a QR code, described below.

At 406, an initial check of a selected area of the image is performed to determine whether a QR code may be present. Performing an initial check can help mitigate computational costs associated with attempting to decode non-QR code images, for example. As described in FIG. 2, for example, a user may frame (e.g., 204) or center the area of the image that comprises the QR code. This may be performed during the image capture (e.g., by presenting a frame or target on the screen for the user to use during image capture) or after the image is captured (e.g., by providing for the user to frame the image during some processing). In one embodiment, a combination of the DS, BR and EIS criteria for the QR code are determined, and used to perform the initial check.

At 408, a DS for a histogram of the grayscale image is selected that mitigates potential image noise. For example, a lower (L) and upper (U) 5% value of the histogram can be selected, where the DS for the selected area of the image is U−L+1. At 414, this dynamic grayscale range can be compared against a desired threshold value to determine if a QR code is present in the selected area. For example, the threshold can be based on experimentation, where a selected experimental value is divided into the 256 value grayscale range (e.g., 256/32). In this example, if the DS for the histogram of the grayscale image is greater than this threshold, an QR code may be present.

At 410, a BR is calculated by counting black cells in the image. In one embodiment, the selected area of the image can be divided into large squares (e.g., macro-blocks), such as by quartering the selected area of the image (e.g., a 64×64 image area can be divided into four 32×32 macro-blocks). In this embodiment, the black cells can be counted in the respective large squares to get a black-cell ratio (e.g., when compared against white cells). Further, in one embodiment, the image (or selected area of the image) can be binarized into a two color scheme (e.g., black and white) in order to facilitate in the BR determination.

At 414, the BR can be compared against a desired threshold to determine if a QR code may be present in the selected area of the image. For example, a threshold may be determined from experimentation that comprises a range of ratios (e.g., 0.2 to 0.7) which can comprise a QR code. In this example, if the BR for the selected area of the image is within the threshold range (e.g., 0.2≦BR≦0.7) a QR code may be present.

At 412, edge gradients in the selected area of the image are evaluated to determine the EIS. For example, as described above, a Sobel mask (or some other edge detection technique) can be used to determine edge gradients. The QR code comprises a plurality of distinct edges, particularly when binarized, due to the black and white modules comprising the code. In this embodiment, the edge gradients can be summed to determine the EIS for the selected area, or for respective “macro-blocks” of the selected area, for example.

At 414, the determined EIS can be compared against a desired threshold value to check if a QR code may be present in the selected area of the image. For example, the threshold may comprise the DS multiplied by a size of the area of the image for which the EIS was determined (e.g., threshold=DS×macro-block-size (32×32)). Further, for example, a threshold may be determined by experimentation. In this embodiment, if the EIS is greater than the threshold, a QR code may be present, for example, in the “macro-block.” In this way, for example, those large grid squares (macro-blocks) that may comprise a QR code can be selected for QR code extraction.

Having determined that a QR code may be present in the selected are of the image, the QR code can be extracted, at 416. At 418, extracting the QR code comprises dividing the selected area into a grid, such as where respective squares of the grid comprise small portions (micro-blocks) of the selected area (e.g., 8×8 grid squares of a 64×64 image selected area). At 420, an EIS can be determined for the respective grid areas, and compared against a desired threshold.

In one embodiment, the “micro-blocks” that fall within the macro-blocks that were determined to potentially comprise the QR code in the initial check, as described above, can be “seed” blocks, comprising a region of interest (ROI) for a region growing process. For example, these micro-blocks can be set as comprising an ROI initially, and other micro-blocks can be evaluated (e.g., EIS checked against threshold) to determine if they comprise ROIs. As respective micro-blocks are evaluated an overall ROI or QR code bounding area can be expanded based on the evaluations, at 422.

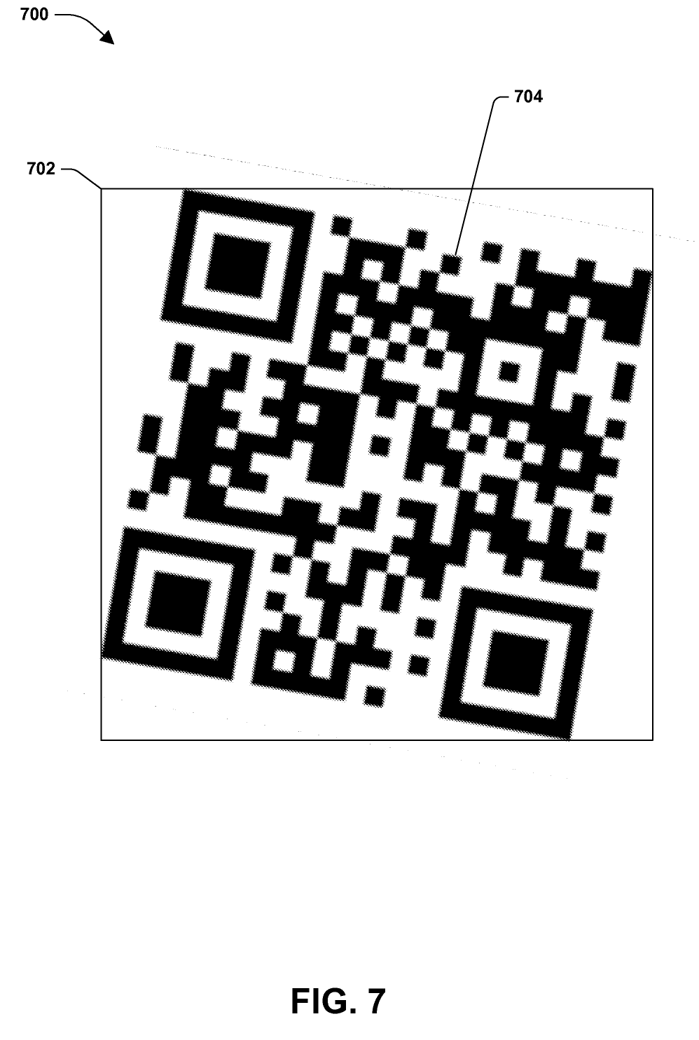

For example, as evaluation and expansion continue, a resulting bounding area can comprise the entire QR code, while having a smallest amount of area (e.g., just big enough to encompass the QR code). FIG. 7 is an illustration of an example QR code 700. In this example 700, the QR code 704 is rotated slightly (e.g., due to camera angle during image capture). Further, a bounding area 702 (e.g., bounding box) has been expanded to be large enough to include the entire QR code 704 in its rotated state. This example 700, illustrates that the bounding box 702 comprises the smallest area that can contain the entire QR code 704.

In one embodiment, the region grow act can contains two sub acts, a first act calculates the micro-block status, and a second act determines the QR code bounding are according to a micro-block status. In this embodiment, respective micro-blocks can have four statuses comprising: NOT_EVALUATED—indicating that the micro-block has not been evaluated and flagged; NOT_ROI—Indicating that the micro-block has been evaluated but is not an ROI; ROI_ONCE—indicating that the micro-block is an ROI and has been grown in the first act; and ROI_TWICE—indicating that the micro-block is a ROI and has been grown in the second act.

In this embodiment, in both acts, respective region-grow cycles use a top micro-block in a stack as seed blocks, and they grow from the seed block in four directions (e.g., LEFT, RIGHT, UP, and DOWN). For the first act, for example, the LEFT growing direction procedure (and other directions) comprises:
1) Move the seed block to the left, if the micro-block has been evaluated (status is not NOT_EVALUATED), then try the other growing direction;
2) Determine EIS in the center of micro-block, if the sum is larger than threshold, then continue checking, otherwise, set the block status as NOT_ROI, and try the other growing direction.

For the second act, for example, the LEFT region growing procedure (and other directions) comprises:
1) If status is not ROI_ONCE, try other growing direction;
2) Update left-most block index;
3) If current block is considered too narrow (e.g., one micro-block in size) an opening, try another growing direction.
4) Update current block status as ROI_TWICE, return to stack;

At 424 in the exemplary embodiment 400 of FIG. 4, the bounding area that comprises the QR code is extracted (e.g., stored to memory). At 426, dimensional parameters of the extracted bounded area that comprises the QR code comprises are verified to be within a desired range for QR code detection. For example, a QR code is typically square (e.g., see FIG. 3, 306); however, as described above, an image of the QR code can be distorted due to angle of image capture and other factors. Because the QR code may be rotated, stretched or have some other perspective transformation, for example, the bounding area can be checked to see if it is of a shape for which a QR code can be detected.

In one embodiment, a width and height of the bounding area can be determined and compared against a threshold value. For example, a threshold value may be determined through experimentation, such as 32 pixels long. In this example, if the height and width of the bounding area are greater than the threshold (e.g., 32 pixels) a QR code may be able to be detected. Further, a ration of the width to the height of the bounding area can be determined and compared against a threshold. For example, a threshold can comprise a ratio range, such as 1/3 to 3, and if the bounding area ratio falls within this threshold range as QR code may be able to be detected.

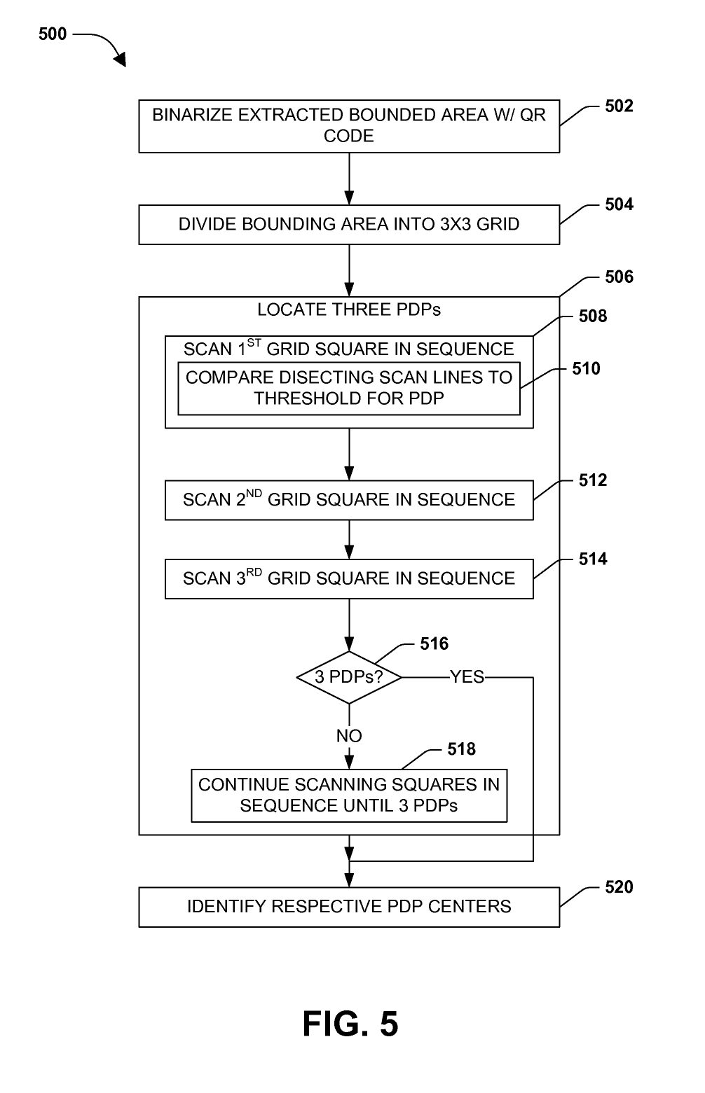

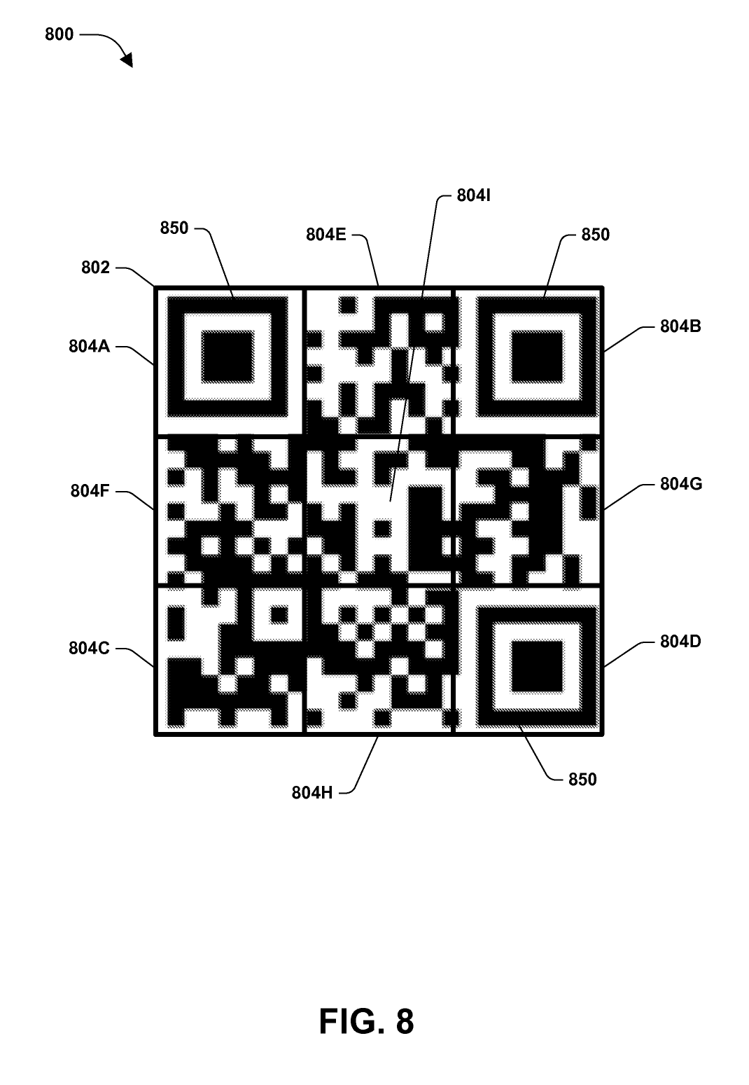

FIG. 5 is a flow diagram illustrating an exemplary embodiment 500 of a portion of a method where PDPs can be identified for the QR code. At 502, the extracted bounded area (e.g., 702 0f FIG. 7) can be binarized, for example, from a grayscale version if not already binarized. The bounded area is divided into a three by three grid, comprising nine grid squares, at 504. FIG. 8 illustrates an example QR code 800, where a grid 802 has been overlaid to divide the QR code into a plurality of grid squares 804A-I.

At 506, the three PDPs can be located in the bounded area comprising the QR code. In one embodiment, in order to determine where the PDPs are located in the QR code, respective areas of the grid are scanned in a desired sequence that provides for a least number of grid square scans that can identify the three PDPs 850. For example, because the PDPs 850 are typically located at the corners of the QR code, and the bounded area comprises the smallest sized box that bounds the entire QR code, the four corners of the grid may comprise the first four scans in the desired sequence.

In the example QR code 800 of FIG. 8, the grid squares 804A-D can comprise the first four scanned grid squares, for example. At 508 of FIG. 5, the first grid square in the sequence (e.g., 804A) can be scanned, by comparing one or more dissecting scan lines to a threshold for a PDP, at 510. In one embodiment, contrasted color segment lengths of the grid square can be determined along one or more scan lines that dissect the grid square. Further, the contrasted color segment lengths for the scan line can be compared with the desired threshold for the PDP.

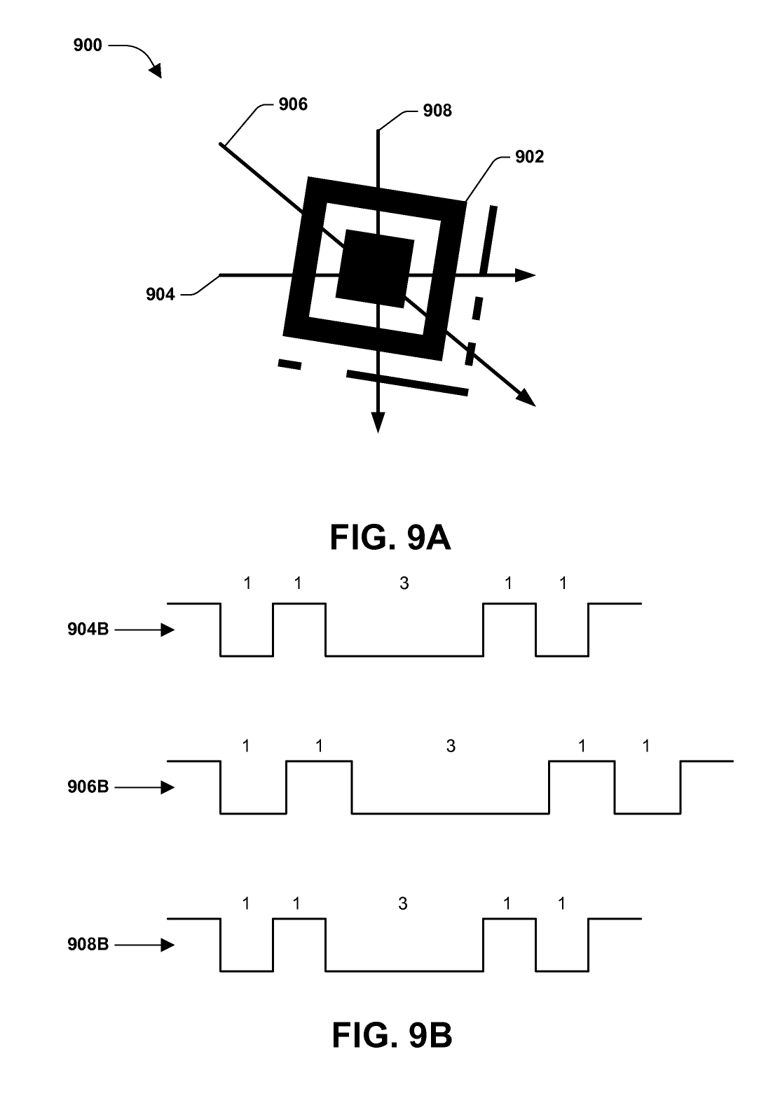

FIGS. 9A & B illustrate an example grid square scan 900. A PDP 902 may be located in a grid square (e.g., 804A of FIG. 8), in this example, slightly rotated. A first scan line 904 dissects the PDP 902 horizontally. In this example 900, for the scan line 904, a number of modules for respective colors (e.g., in this binarized black and white version) can be counted along the scan line in sequence. For example, 904B of FIG. 9B illustrates the number sequence along the scan line 904. The sequence comprises one black module, one white module, three black modules, one white module, and one black module (e.g., 11311 sequence). PDPs are typically designed with this same ratio, which can be used as the desired threshold, for example, so that they may be more readily recognized for QR code decoding.

Further, as illustrated by scan lines 906 and 908, regardless of the rotation and angle at which the scan line dissects the PDP, the module sequence for the PDP is still 11311. Scan line 906 dissects the rotated PDP diagonally, and 906B of FIG. 9B illustrates a same 11311 sequence. Additionally, scan line 908 dissects the PDP vertically, and 908B of FIG. 9b illustrates the same 11311 module sequence of black and white contrasted colors. In this way, for example, respective grid squares can be scanned using this scan line technique to determine if the grid square comprises a PDP.

In FIG. 5, at 512, a second grid square is scanned (e.g., 804B), by comparing the dissecting scan line(s) to the threshold, and a third grid square is scanned (e.g., 804C), by comparing the dissecting scan line(s) to the threshold, at 514. If the three PDPs are identified after three grid square scans, at 516, the scanning sequence can end. However, if the three PDPs are not yet identified, the scanning of grid squares can continue until three PDPs have been identified, at 518.

For example, the sequence can continue as illustrated in FIG. 8, by going to grid square 804D then 804E, through to 804I in sequence. As an example, some QR code may be distorted where a PDP is located in grid squares 804E and 804H, such as when QR code is stretched like a parallelogram. Other locations may also be apparent for the PDPs. It will be appreciated the scanning sequence is not limited to the example sequences described herein. For example, those skilled in the art may devise alternate sequences, such as based on experimentation and/or designed for particular embodiments.

At 520 in the exemplary embodiment 500, the center of the respective PDPs can be identified. In one embodiment, a plurality of scan lines that dissect the PDP at a plurality of locations can be examined, and compared to a desired threshold. Further, the PDP center area can be estimated based on the results of the plurality of scan lines across the grid square.

In one embodiment, after determining the PDP region by the simple line checks, described above, a verification procedure can occur. The PDP line center and vertical segments that cross that center can be determined as a center point and compared against the threshold to verify. The center point can then be moved to the left (and right) by one module's length, and the vertical lines verified. The center point can then be moved downwards (or upward) by one module's length, and the horizontal line verified.

The PDP center is estimated according to the verified vertical center line center, and from the estimated center, along with diagonal verifying (e.g., Left-Up and Right-Up checking). In this embodiment, the PDP can be scanned in a sequence of rows dissecting the PDP, yielding an actual horizontal center; then scanning in a sequence of columns, yielding an actual vertical center.

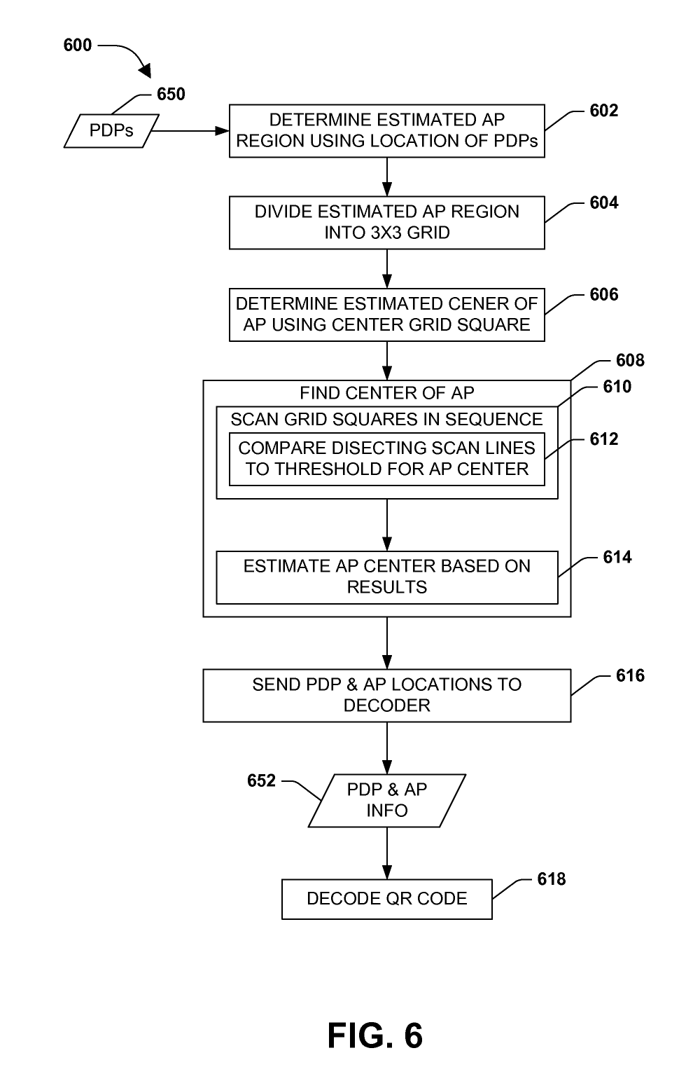

FIG. 6 is a flow diagram illustrating an exemplary embodiment 600 of a portion of a method where AP center can be determined. At 602, an estimated AP region is determined using the PDP locations 650. As described above, the AP can be used for aligning a distorted QR code, for example. The APs are typically located in non-PDP areas; therefore, the location of the PDPs can be used to identify a location of an AP. Further, as described above, a QR code may comprise none or a plurality of APs, for example, depending on a version of the QR code.

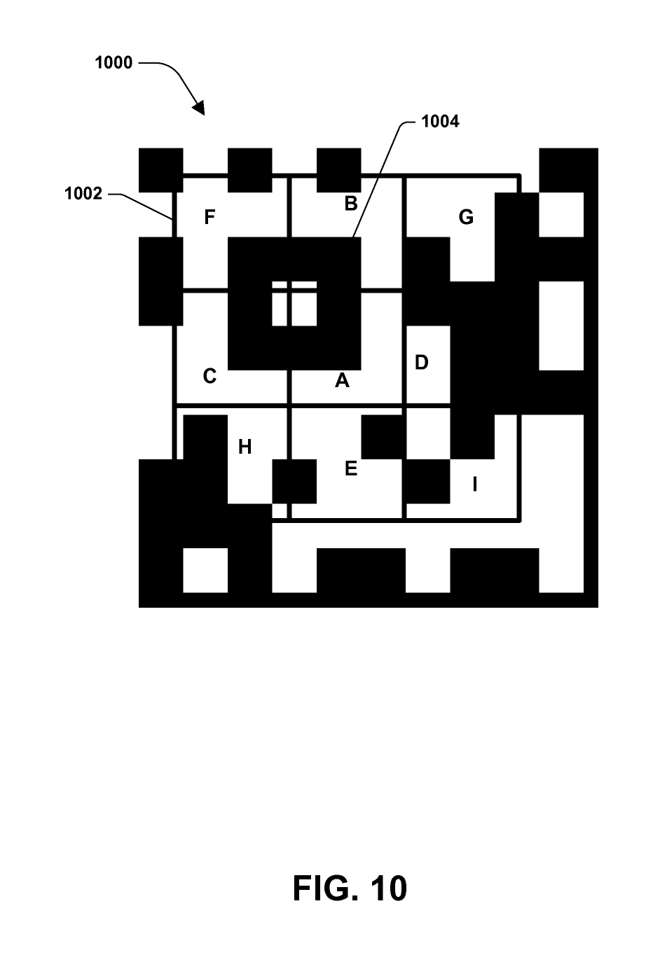

At 604, the estimated AP region can be divided into a three by three grid, comprising none grid squares. FIG. 10 illustrates an example estimated AP region 1000, where a grid 1002 has been laid over the region comprising the AP 1004. At 606, the estimated center of the AP can be determined by using a center grid square of the grid. For example, in FIG. 10, the center grid square 1002A can comprise the estimated center of the AP.

At 608, the actual center of the AP can be determined. At 610, finding the center area of the AP can comprise examining respective areas (grid squares) of the grid (e.g., 1002) by scanning the grid squares in a desired sequence that provides a least number of grid square scans to identify the AP center area. For example, the AP center may often be located at the center of the grid (e.g., 1002A); therefore, this grid square may be a desired location to begin scanning for the actual center. Additionally, the grid squares located to the left 1002C, right 1002D, up 1002B and down 1002E from the center 1002A may be likely locations for the AP center, for example if the QR code is slightly distorted.

At 612, scanning the second grid square can comprise determining contrasted color segment lengths of the grid square along one or more scan lines that dissect the grid square, and comparing the contrasted color segment lengths with a desired threshold for the AP. For example, much like the PDP, the AP can have a typical scan line sequence of alternating color contrast (e.g., black and white) lengths. In the example AP 1000 of FIG. 10, the AP comprises concentric squares of alternating white, black, and white, respectively comprising one module in length. In alternate embodiments, the binarization may not have provided a “clean” AP, such that the center square is filled. Therefore, in this embodiment, alternate scanning thresholds may be used.

At 614, scan lines that dissect a grid square at a plurality of locations can be compared against the desired threshold for the AP, and the AP center area can be estimated based on the results of the plurality of scan lines across the second grid square. For example, for the respective grid squares, a plurality of horizontal and vertical scan lines can be used, and the resulting module contrast pattern can be compared to the threshold (e.g., 111 for an AP, or 3 if the center is filled). In this way, in one embodiment, the actual center can be determined, and a difference between the estimated center of the AP region can be determined to estimate the potential distortion for the QR code, for example.

At 616 in the exemplary embodiment 600 of FIG. 6, the PDP and AP locations 652 (e.g., and possible distortion) are sent to a decoder. The decoder, knowing the orientation and distortion of the QR code, can now decode the QR code, such as providing some web address, coupon, contact information, etc., at 618.

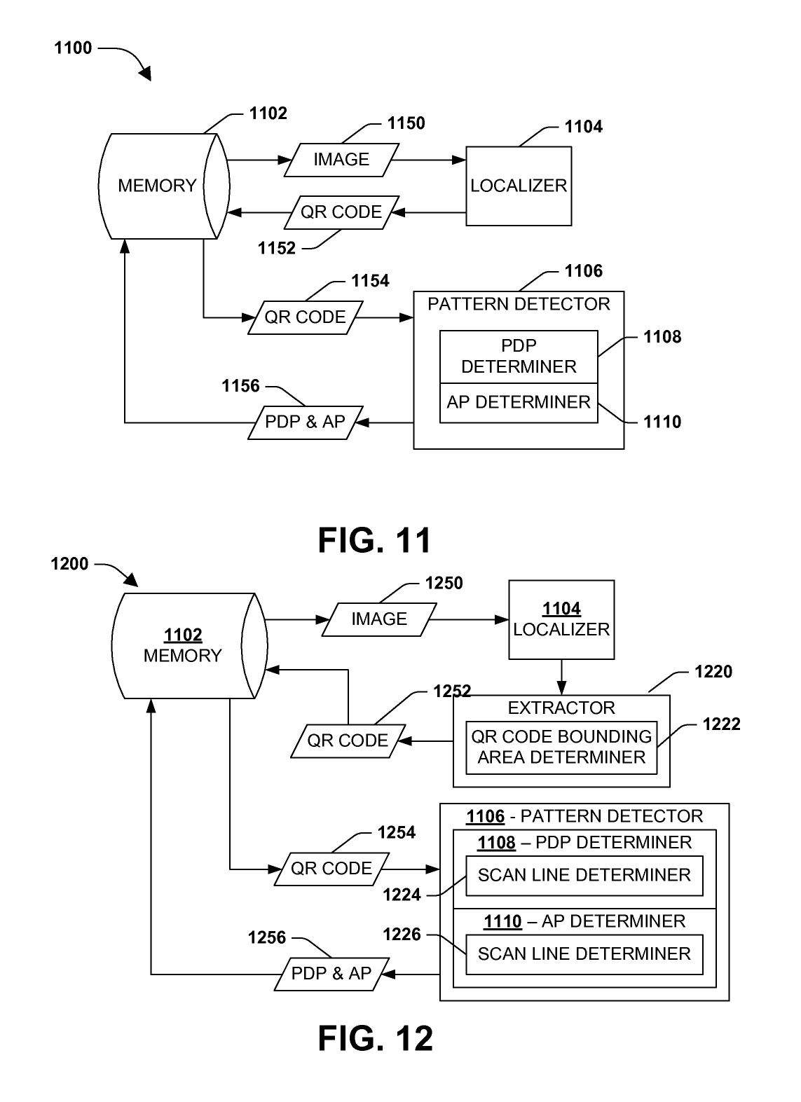

A system may be devised that provides for improved detection of quick response (QR) codes. For example, the system may be deployed on mobile devices that have an ability to capture images, in order to provide for a fast, real-time experience in detecting the QR codes. FIG. 11 is a block diagram illustrating an exemplary system 1100 for detecting a QR code.

A computer-based memory component 1102 can be used to store an image 1150 comprising a QR code 1152. For example, a user may capture an image (e.g., picture or video) of a QR code, which is then stored to memory, such as RAM or some non-volatile memory. A localization component 1104 is operably coupled with the memory component 1102, and can identify an area of the image 1150 that comprises the QR code 1152 by using a combination of determined criteria.

In this embodiment, the determined criteria comprise pixel dynamic scale (DS), black-cell ratio (BR), and edge intensity sum (EIS). The DS can comprise a dynamic range of grayscale for a histogram of the image, for example, determined by an attempt to mitigate an amount of image noise. The BR can comprise a number of black cells in an image (or portion thereof) compared with white cells, for example, particularly in a binarized version of the image (e.g., comprising merely black and white cells). The EIS can comprise a sum of the edge gradients in an image (or portion thereof), such as determined by an edge detector (e.g., a Sobel mask-type detector).

A pattern detection component 1106 is operably coupled with the memory component 1102 and can detect a pattern position for the QR code 1154, such as comprised in the captured image from the memory. The pattern detection component 1106 comprises a position detection pattern (PDP) determination component 1108 that determines a location of a PDP 1156 located in the QR code 1154 by scanning respective areas of a first grid comprising the QR code. That is, for example, the first grid is laid over the QR code, and respective areas of the grid are scanned for the PDP, such as by using dissecting scan lines and comparing results to a threshold.

The pattern detection component 1106 further comprises an alignment pattern (AP) determination component 1110 that determines a location of an AP 1156 in the QR code, if one is present, by examining respective areas of a second grid comprising an estimated AP region. In this embodiment, the estimated AP region is estimated from the location of the PDPs, and is used to find a center area of the AP. That is, for example, the AP can be located in corner where the PDPs are not, and a grid can be overlaid over this estimated AP region. Further, in this example, the respective areas of the grid can be scanned for the AP center, such as by using scan lines. In this way, for example, a distortion of the QR code may be identified by comparing an estimated AP center, with the identified actual center.

FIG. 12 is a component diagram illustrating an exemplary embodiment 1200 of a portion of a system, where the QR code can be extracted from the image. An extraction component 1220 extracts the identified area of the image that comprises the QR code 1252. The extraction component 1220 comprises a QR code bounding area determination component 1222 that identifies a bounding area of the image 1250 that comprises a smallest area that bounds the QR code. That is, for example, the bounding area determination component 1222 can generate a box around the QR code that includes all of the QR code, but also comprises the smallest area that is able to bound the QR code. In this example, the extraction component 1220 can extract this bounding area that comprises the QR code 1252, which can be stored in the memory component 1102.

In this embodiment, the PDP determination component 1108 comprises a scan line determination component 1224 that determines contrasted color segment lengths of the first grid square along one or more scan lines that dissect the first grid square, and compares the contrasted color segment lengths for the scan line with a desired threshold for a PDP. That is, as an example, the scan line determination component 1224 can facilitate in identifying a PDP in the QR code 1254, by scanning respective grid squares of the grid overlaying the QR code, to identify a location of the PDPs 1256.

Further, in this embodiment 1200, the AP determination component 1110 comprises a scan line determination component 1226 that determines contrasted color segment lengths of the second grid square along one or more scan lines that dissect the second grid square, and compares the contrasted color segment lengths for the scan line with a desired threshold for an AP. That is, as an example, the scan line determination component 1226 can facilitate in identifying an AP 1256 in the QR code 1254, by scanning respective grid squares of the grid overlaying the QR code, to identify a location of the AP 1256.

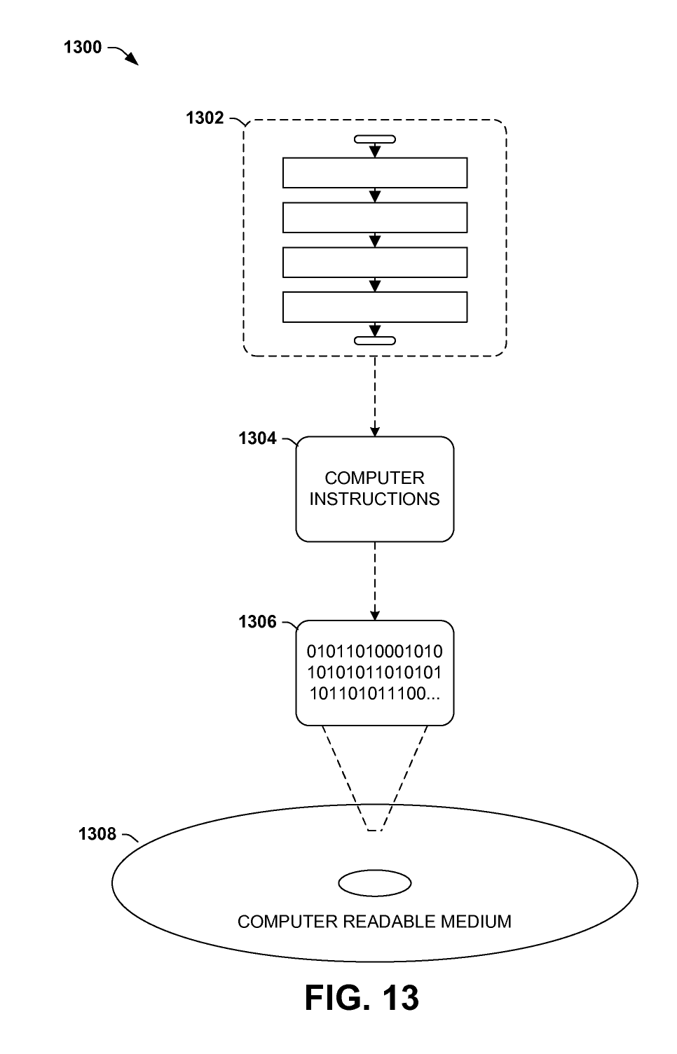

Still another embodiment involves a computer-readable medium comprising processor-executable instructions configured to implement one or more of the techniques presented herein. An exemplary computer-readable medium that may be devised in these ways is illustrated in FIG. 13, wherein the implementation 1300 comprises a computer-readable medium 1308 (e.g., a CD-R, DVD-R, or a platter of a hard disk drive), on which is encoded computer-readable data 1306. This computer-readable data 1306 in turn comprises a set of computer instructions 1304 configured to operate according to one or more of the principles set forth herein. In one such embodiment 1302, the processor-executable instructions 1304 may be configured to perform a method, such as the exemplary method 100 of FIG. 1, for example. In another such embodiment, the processor-executable instructions 1304 may be configured to implement a system, such as the exemplary system 1100 of FIG. 11, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

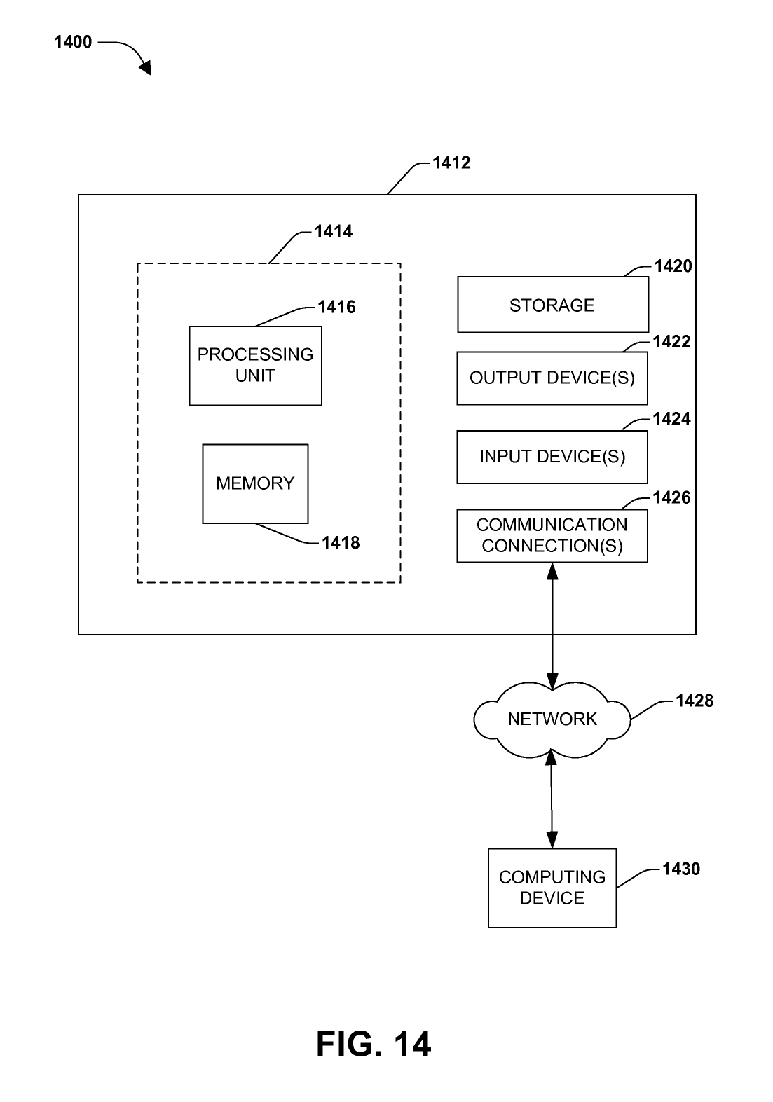

FIG. 14 and the following discussion provide a brief, general description of a suitable computing environment to implement embodiments of one or more of the provisions set forth herein. The operating environment of FIG. 14 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 14 illustrates an example of a system 1410 comprising a computing device 1412 configured to implement one or more embodiments provided herein. In one configuration, computing device 1412 includes at least one processing unit 1416 and memory 1418. Depending on the exact configuration and type of computing device, memory 1418 may be volatile (such as RAM, for example), non-volatile (such as ROM, flash memory, etc., for example) or some combination of the two. This configuration is illustrated in FIG. 14 by dashed line 1414.

In other embodiments, device 1412 may include additional features and/or functionality. For example, device 1412 may also include additional storage (e.g., removable and/or non-removable) including, but not limited to, magnetic storage, optical storage, and the like. Such additional storage is illustrated in FIG. 14 by storage 1420. In one embodiment, computer readable instructions to implement one or more embodiments provided herein may be in storage 1420. Storage 1420 may also store other computer readable instructions to implement an operating system, an application program, and the like. Computer readable instructions may be loaded in memory 1418 for execution by processing unit 1416, for example.

The term “computer readable media” as used herein includes computer storage media. Computer storage media includes volatile and nonvolatile, removable and non-removable media implemented in any method or technology for storage of information such as computer readable instructions or other data. Memory 1418 and storage 1420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1412. Any such computer storage media may be part of device 1412.

Device 1412 may also include communication connection(s) 1426 that allows device 1412 to communicate with other devices. Communication connection(s) 1426 may include, but is not limited to, a modem, a Network Interface Card (NIC), an integrated network interface, a radio frequency transmitter/receiver, an infrared port, a USB connection, or other interfaces for connecting computing device 1412 to other computing devices. Communication connection(s) 1426 may include a wired connection or a wireless connection. Communication connection(s) 1426 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1412 may include input device(s) 1424 such as keyboard, mouse, pen, voice input device, touch input device, infrared cameras, video input devices, and/or any other input device. Output device(s) 1422 such as one or more displays, speakers, printers, and/or any other output device may also be included in device 1412. Input device(s) 1424 and output device(s) 1422 may be connected to device 1412 via a wired connection, wireless connection, or any combination thereof. In one embodiment, an input device or an output device from another computing device may be used as input device(s) 1424 or output device(s) 1422 for computing device 1412.

Components of computing device 1412 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1412 may be interconnected by a network. For example, memory 1418 may be comprised of multiple physical memory units located in different physical locations interconnected by a network.

Those skilled in the art will realize that storage devices utilized to store computer readable instructions may be distributed across a network. For example, a computing device 1430 accessible via network 1428 may store computer readable instructions to implement one or more embodiments provided herein. Computing device 1412 may access computing device 1430 and download a part or all of the computer readable instructions for execution. Alternatively, computing device 1412 may download pieces of the computer readable instructions, as needed, or some instructions may be executed at computing device 1412 and some at computing device 1430.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for detecting a quick response (QR) code, comprising:
localizing an area of an image comprising a QR code by using a computer-based processor to combine pixel dynamic scale (DS), black-cell ratio (BR), and edge intensity sum (EIS) criteria determination to identify the QR code; and
detecting a pattern for the QR code comprising:
determining whether a position detection pattern (PDP) is located in respective areas of a first grid comprising the QR code; and
identifying an alignment pattern (AP), if present, comprising:
estimating an AP region using the PDPs; and
finding a center area of the AP by examining respective areas of a second grid comprising the estimated AP region.

2. The method of claim 1, localizing the area of the image comprising:
determining if a selected area of the image comprises a QR code;
extracting a QR code area comprising the QR code if present; and
verifying the extracted QR code area comprises dimensional parameters that are within a desired range for QR code detection.

3. The method of claim 2, determining criteria, comprising:
selecting a DS for a grayscale histogram of the image that mitigates noise;
calculating the BR by counting a number of black cells in the selected area; and
evaluating an edge gradient in the selected area to determine the EIS.

4. The method of claim 2, determining if the selected area of the image comprises a QR code comprising determining if the DS, BR and EIS criteria meet respective desired thresholds for the QR code area.

5. The method of claim 2, extracting the QR code area comprising extracting a QR code bounding area, comprising:
dividing the selected area into a third grid;
evaluating respective third grid boxes by comparing the EIS to a desired threshold; and
expanding the bounding area to comprise the QR code based on the evaluation of the third grid boxes.

6. The method of claim 1, detecting a pattern for the QR code comprising dividing a QR code bounding area into the first grid comprising a three by three grid of squares of a same size.

7. The method of claim 6, determining whether a PDP is located in respective areas of the first grid comprising scanning the respective first grid squares in a desired sequence that provides a least number of first grid square scans to identify the PDPs for the QR code.

8. The method of claim 6, scanning the first grid square comprising:
determining contrasted color segment lengths of the square along one or more scan lines that dissect the grid square; and
comparing the contrasted color segment lengths for the scan line with a desired threshold for a PDP.

9. The method of claim 6, comprising identifying the PDP center area, comprising:
comparing scan lines that dissect the grid square at a plurality of locations to a desired threshold for the PDP; and
estimating the PDP center area based on the results of the plurality of scan lines across the grid square.

10. The method of claim 1, estimating an AP region using the PDPs comprising selecting a region in a corner of the QR code that does not comprise a PDP.

11. The method of claim 1, identifying an AP comprising dividing the estimated AP region into the second grid comprising a three by three grid of squares of a same size.

12. The method of claim 1, finding a center area of the AP by examining respective areas of a second grid comprising scanning the respective first grid squares in a desired sequence that provides a least number of second grid square scans to identify the AP center area.

13. The method of claim 12, comprising scanning the second grid square comprising:
determining contrasted color segment lengths of the square along one or more scan lines that dissect the second grid square; and
comparing the contrasted color segment lengths for the scan line with a desired threshold for the AP.

14. The method of claim 12, comprising identifying the AP center area, comprising:
comparing scan lines that dissect the second grid square at a plurality of locations to a desired threshold for the AP; and
estimating the AP center area based on the results of the plurality of scan lines across the second grid square.

15. The method of claim 1, comprising binarizing the area of the image comprising the QR code.

16. A system for detecting a quick response (QR) code, comprising:
a computer-based memory component configured to store an image comprising a QR code;
a localization component operably coupled with the memory component and configured to identify an area of the image that comprises the QR code by using a combination of determined criteria, the criteria comprising:
pixel dynamic scale (DS);
black-cell ratio (BR); and
edge intensity sum (EIS);
a pattern detection component operably coupled with the memory component and configured to detect a pattern position for the QR code, comprising:
a position detection pattern (PDP) determination component configured to determine a location of a PDP located in the QR code by scanning respective areas of a first grid comprising the QR code; and
an alignment pattern (AP) determination component configured to determine a location of an AP in the QR code, if present, by examining respective areas of a second grid comprising an estimated AP region, estimated from the PDPs, to find a center area of the AP.

17. The system of claim 16, comprising an extraction component configured to extract the identified area of the image that comprises the QR code comprising a QR code bounding area determination component configured to identify a bounding area of the image that comprises a smallest area that bounds the QR code.

18. The system of claim 16, the PDP determination component comprising a scan line determination component configured to:
determine contrasted color segment lengths of a first grid square along one or more scan lines that dissect the first grid square; and
compare the contrasted color segment lengths for the scan line with a desired threshold for a PDP.

19. The system of claim 16, the AP determination component comprising a scan line determination component configured to:
determine contrasted color segment lengths of a second grid square along one or more scan lines that dissect the second grid square; and
compare the contrasted color segment lengths for the scan line with a desired threshold for an AP.

20. A computer readable storage medium comprising computer executable instructions that when executed via a processor on a computer perform a method for detecting a quick response (QR) code, comprising:
localizing an area of an image comprising a QR code by using a computer-based processor to combine pixel dynamic scale (DS), black-cell ratio (BR), and edge intensity sum (EIS) criteria determination to identify the QR code; and
detecting a pattern for the QR code comprising:
determining whether a position detection pattern (PDP) is located in respective areas of a first grid comprising the QR code; and
identifying an alignment pattern (AP), if present, comprising:
estimating an AP region using the PDPs; and
finding a center area of the AP by examining respective areas of a second grid comprising the estimated AP region.
